(19) United States
(12) Patent Application Publication
(10) Pub. No.: US 2002/0095445 A1
(43) Pub. Date: Jul. 18, 2002

(54) Content conditioning method and apparatus for internet devices

(75) Inventors: Yasser alSafadi, Yorktown Heights, NY (US); Amr F. Yassin, Ossining, NY (US)

Correspondence Address: Jack E. Haken, Corporate Patent Counsel, U.S. Phillips Corporation, 580 White Plains Road, Tarrytown, NY, 10591, US

(73) Assignee: Philips Electronics North America Corp.

(21) Appl. No.: 09/726,797

(22) Filed: Nov. 30, 2000

(51) Int. Cl. G06F 17/24

(52) U.S. Cl. 707/517; 707/530

(57) ABSTRACT

A content conditioner applies a content profile associated with a given Internet-enabled processing device to a requested extensible mark-up language document or other type of content to be processed for presentation at the device. The resulting conditioned document is further processed using a stylesheet associated with the device, so as to generate an output suitable for presentation at the device. The content profile for the given device comprises one or more operations and corresponding parameters that are required to condition the requested document content for a desired consumption experience at the processing device. For example, the content profile may include a summarization program which specifies a manner in which summarization information derived from the retrieved document is to be presented at the device.

### FIELD OF THE INVENTION

The present invention relates generally to processing devices, such as computers, personal digital assistants (PDAs) and wireless telephones, that may be used to retrieve information over the Internet or other computer network, and more particularly to techniques for processing information content for proper presentation on such devices.

### BACKGROUND OF THE INVENTION

Data processing devices such as desktop or portable computers, personal digital assistants (PDAs), wireless telephones, etc. are often configured to provide access to information available over the Internet. These devices are generally referred to herein as Internet-enabled devices or simply Internet devices. Internet access may be provided in these devices through wired connections, wireless connections or combinations thereof, using well-known conventional communication protocols such as the Internet Protocol (IP).

Extensible mark-up language (XML) is fast becoming the dominant language for describing content delivered over the Internet. The XML standard describes a class of data objects called XML documents and the behavior of computer programs which process such documents. XML documents are made up of storage units called entities, which contain either parsed or unparsed data. Parsed data is made up of characters, some of which form character data, and some of which form markup. Markup for a given XML document encodes a description of the storage layout and logical structure of that document. XML provides a mechanism to impose constraints on the storage layout and logical structure. Additional details regarding conventional XML may be found in XML 1.0 (Second Edition), World Wide Web Consortium (W3C) Recommendation, October 2000, www.w3.org/TR/REC-xml, which is incorporated by reference herein.

FIG. 1 illustrates conventional processing of an XML document using the extensible stylesheet language (XSL). XSL is used to define stylesheets for transforming and formatting the content of an XML document so as to generate content that is suitable for a particular device. In the figure, an original XML document 10 is processed by an XSL engine 12. The XSL engine 12 has access to stylesheets 14A and 14B corresponding to devices A and B, respectively. The figure illustrates the processing of XML document 10 using stylesheet 14A to generate a presentation 16A for device A. The steps of the process as indicated in the figure are as follows:

1. Obtain the original XML document 10 to be presented on device A.

2. Select the corresponding stylesheet 14A for device A.

3. The XSL engine 12 given the XML document 10 and the stylesheet 14A for device A generates the appropriate presentation 16A for device A.

An example of an approach of the type illustrated in FIG. 1 is described in greater detail in U.S. Pat. No. 6,023,714 issued Feb. 8, 2000 and entitled “Method and System for Dynamically Adapting the Layout of a Document to an Output Device.”

One technique known in the art for extending the capability of XSL stylesheets is described in PCT International Application No. WO 00/54174 published Sep. 14, 2000 and entitled “Extending the Capabilities of an XSL Style Sheet to Include Components for Content Transformation.” In this technique, a stylesheet is configured to include an external component reference which when called executes a specified processing method the results of which are placed in a transformed document generated by processing the stylesheet. However, this approach is inefficient in that it requires alteration of stylesheets to incorporate external component references. Since different external components will typically be needed for different types of devices, this can lead to unnecessary duplication of stylesheets. In addition, this approach does not provide efficient handling of device profiles, and is not readily separable between a client and server in a given client-server architecture.

It is therefore apparent that a need exists in the art for a technique for conditioning content for presentation on a variety of different types of devices without alteration of the corresponding stylesheets.

### SUMMARY OF THE INVENTION

The invention provides improved techniques for conditioning content for presentation on Internet devices and other types of processing devices.

In accordance with one aspect of the invention, a desktop or portable computer, personal digital assistant (PDA), wireless telephone or other Internet-enabled processing device has a content profile associated therewith. The content profile is utilized by a content conditioner to process information content retrieved from the Internet or other network for presentation at the device. The content conditioner in an illustrative embodiment applies the content profile associated with a given device to a requested extensible mark-up language (XML) document or other type of content to be processed for presentation at the device. The resulting conditioned document is further processed using a stylesheet associated with the device so as to generate an output suitable for presentation at the device.

The above-noted content profile for the given device will preferably include one or more operations and corresponding parameters that are required to condition the requested document content for a desired consumption experience at the processing device. For example, the content profile may include a summarization program which specifies a manner in which summarization information derived from the retrieved document is to be presented at the device.

In accordance with a further aspect of the invention, a schema may be determined for the given device, and the conditioned document may be generated in the above-described content conditioner by applying the content profile and the schema to the requested document.

The content conditioner may be implemented using a server-side architecture or a client-side architecture. In the server-side architecture, the content conditioner and a corresponding extensible stylesheet language (XSL) engine are both implemented in a server which stores the requested document for delivery to a client device. The server processes the document so as to generate an output suitable for presentation at the device. In the client-side architecture, the content conditioner and XSL engine are both implemented in the client device. The invention can also be implemented so as to be separated between the client and the server in a given client-server architecture, e.g., with the content conditioner implemented in the server and the XSL engine implemented in the client device.

Advantageously, the content conditioning process of the present invention as allows content in the form of an XML document to be conditioned for appropriate presentation on a wide variety of different devices, without requiring alteration of the corresponding stylesheets.

These and other features and advantages of the present invention will become more apparent from the accompanying drawings and the following detailed description.

### BRIEF DESCRIPTION OF THE DRAWINGS

FIG. 1 illustrates conventional processing of an extensible mark-up language (XML) document using an extensible stylesheet language (XSL) engine.

FIGS. 2A and 2B show different types of displays generated by different devices using content conditioning in an illustrative embodiment of the invention.

FIG. 3 shows the processing of an XML document in the illustrative embodiment of the invention.

FIGS. 4A, 4B and 4C show examples of a content profile that may be used in the processing operations of FIG. 3.

FIGS. 5A and 5B show respective server-side and client-side implementations of the content conditioning of the present invention.

FIG. 6 shows one possible implementation of a server or client device configured to provide the content conditioning of the present invention.

### DETAILED DESCRIPTION OF THE INVENTION

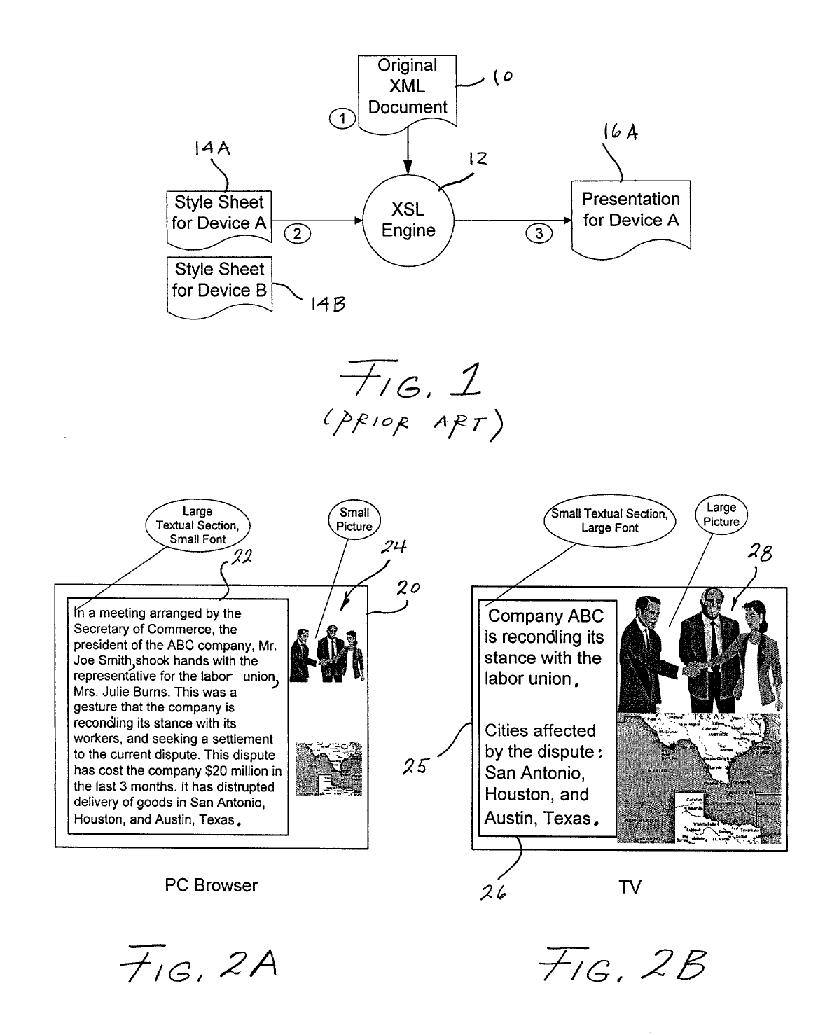

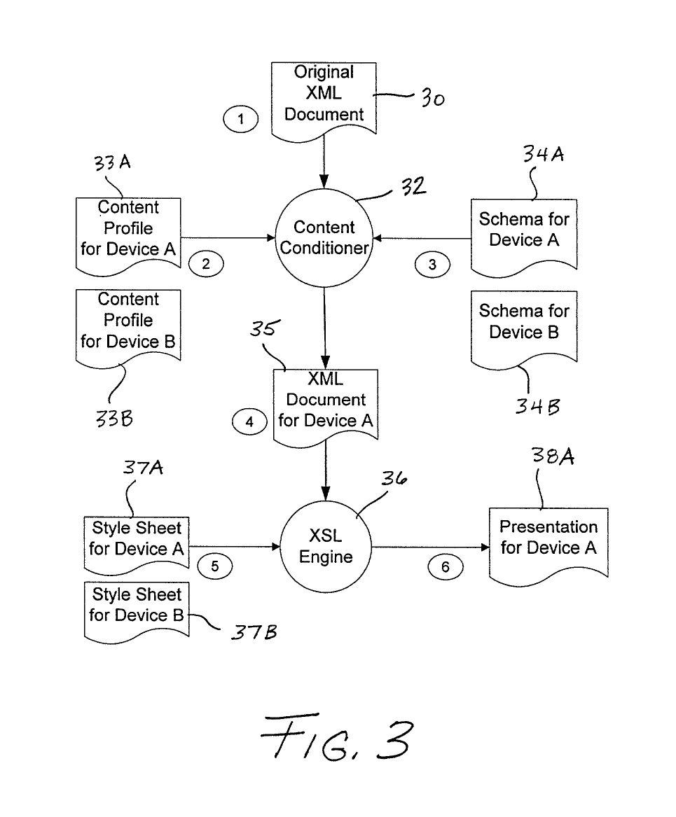

FIGS. 2A and 2B illustrate displays generated using content conditioning in accordance with the present invention. Each of the displays is assumed to be generated from the same original extensible mark-up language (XML) document, such as a web page retrieved over the Internet. The particular content conditioning processing steps used to generate a particular type of display suitable for a given device will be described below in conjunction with FIG. 3.

FIG. 2A shows a display 20 generated by a browser of a personal computer (PC). The display 20 in this example includes a large textual section 22 in a small font and a small picture section 24. The large textual section 22 may correspond to the complete text of at least a designated portion of the original XML document.

FIG. 2B shows a display 25 generated by a television. The display 25 in this example includes a large picture section 28 and a small textual section 26 in a large font.

The content conditioning of the present invention alters retrieved content so as to make it more compatible with the typical usage of a specified device. For example, with reference to FIGS. 2A and 2B, the display 20 which is generated for presentation via a PC browser includes the large textual section 22 and the small picture section 24, since a user of such a device is generally closer to the device and able to read small font text and view small pictures. However, the very same XML document retrieved from the Internet for presentation on a television is processed to generate the display 25 having the small textual section 26 and large picture section 28. This is because a user of the television is typically located further from the display than a user of the PC, such that the small textual section 26 in a large font and the large picture section 28 are appropriate.

It should be noted that the small textual section 26 is not simply a clip of the original document text, or the first 100 characters of such text, etc. Instead, the content conditioning of the present invention summarizes the original document text to produce the words that appear in the small textual section 26, as is apparent from a comparison of the text shown in sections 22 and 26 in the figure. This summarization is an example of one type of content conditioning that may be applied to an XML document in accordance with the invention.

FIG. 3 is a diagram illustrating the content conditioning process in an illustrative embodiment of the invention. As previously noted, this process may be used to generate the different displays 20 and 25 of FIGS. 2A and 2B from a single common XML document. The steps of the process as shown in FIG. 3 are as follows:

1. Obtain an original XML document 30 to be presented on a given device. Such a document may be obtained over the Internet by the given device using well-known conventional techniques. In this example, it is assumed that the given device is a device denoted as device A. The process as shown also supports content conditioning for another device denoted as device B, and can be extended to any desired number of other devices.

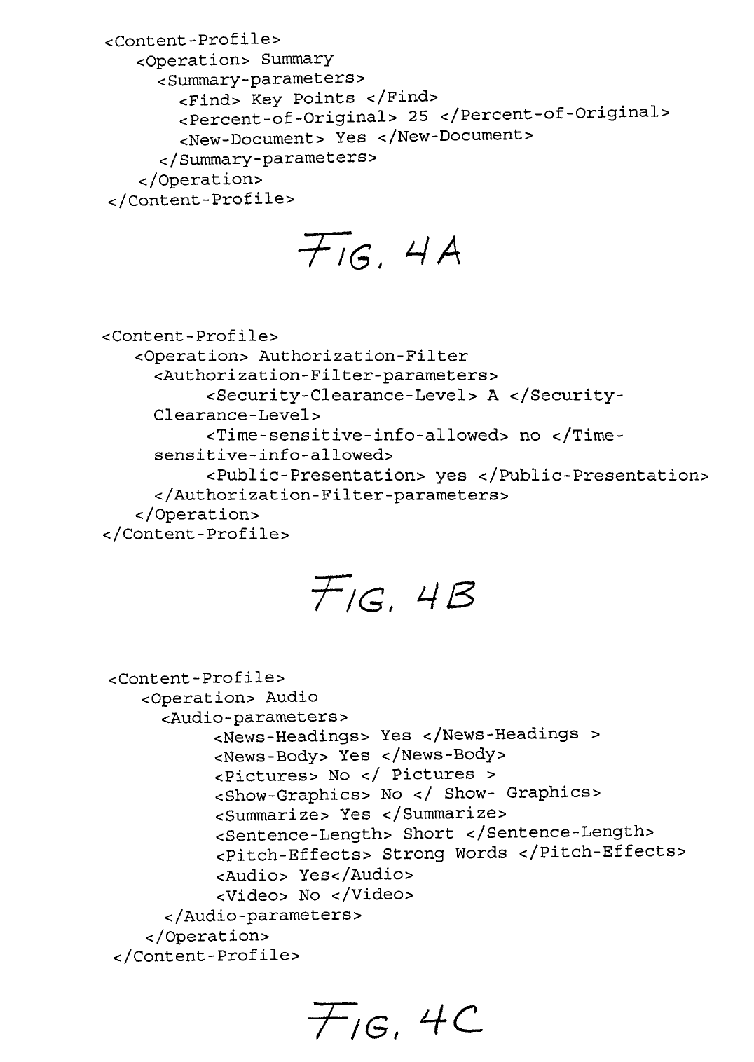

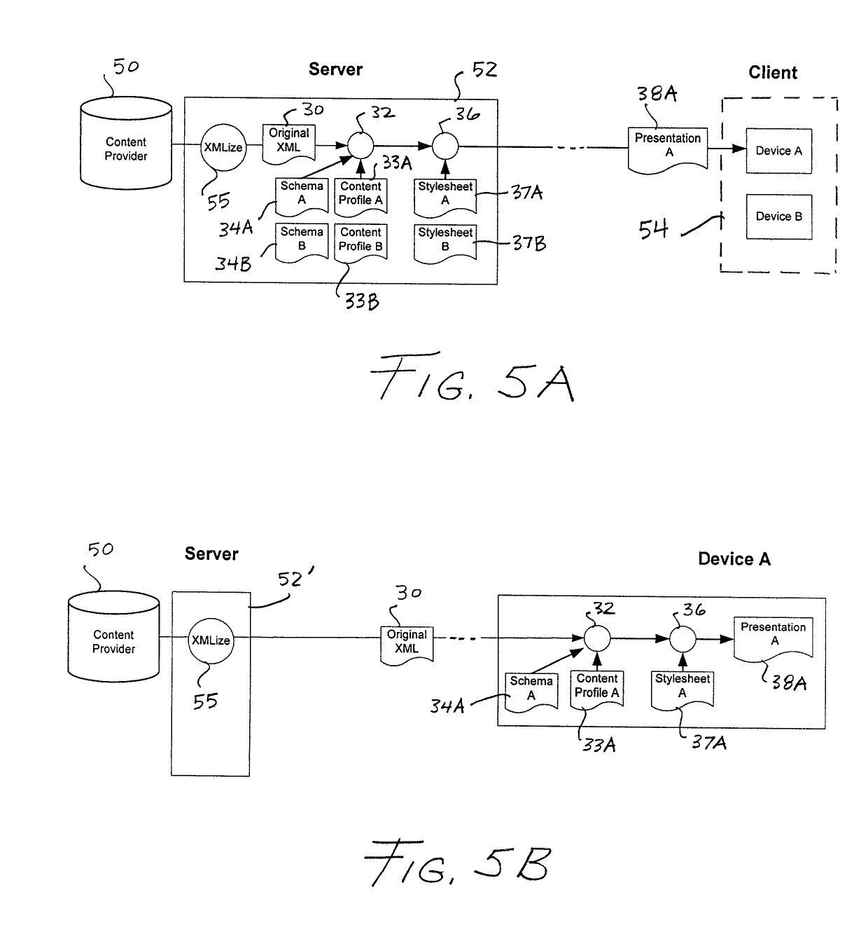

2. Select a content profile for device A. The selected content profile is supplied as an input to a content conditioner 32. The FIG. 3 process selects the content profile 33A for device A. The content profiles not selected in this example include at least a content profile 33B for device B. A given content profile in the illustrative embodiment lists one or more operations and corresponding parameters that are needed to condition the XML document content for the desired consumption experience at a particular device. An example of a content profile which provides summarization of the type illustrated in conjunction with FIGS. 2A and 2B will be described in detail below in conjunction with FIG. 4A. Other content profile examples are described in conjunction with FIGS. 4B and 4C.

3. Select a schema for device A. The selected schema is supplied as another input to a content conditioner 32. The FIG. 3 process selects a schema 34A for device A. The schemas not selected in this example include at least a schema 34B for device B. A given schema can include additional information relevant to the content conditioning process but not appropriate for inclusion in a corresponding content profile. For example, a given schema may include document formatting information appropriate to its associated device. As a more specific example, a schema used in generation of the display 25 shown in FIG. 2B may specify the number of bullet points used in the textual section 26. In other embodiments, the content conditioning information associated with a given content profile and a corresponding schema may be combined into a single information element applied to the content conditioner 32.

4. The content conditioner 32 invokes the operations specified in the content profile 33A and structures the output according to the specified schema 34A. For example, the content profile 33A may include a summarization program of the type shown in FIG. 4A so as to prepare the content for proper consumption at device A. The output of the content conditioner is an XML document 35 configured for appropriate presentation on device A. The XML document 35 is supplied as an input to a conventional extensible stylesheet language (XSL) engine 36 as shown.

5. Select a corresponding stylesheet for device A. The selected stylesheet is supplied as another input to the XSL engine 36. The FIG. 3 process selects a stylesheet 37A for device A. The stylesheets not selected in this example include at least a stylesheet 37B for device B.

6. The XSL engine 36 generates, from the XML document 35 for device A and the stylesheet 37A for device A, a presentation 38A appropriately conditioned for device A. For example, the presentation 38A may represent one of the displays 20 or 25 of FIGS. 2A and 2B.

Advantageously, the content conditioning process of the present invention as illustrated in FIG. 3 allows content in the form of an XML document to be conditioned for appropriate presentation on a wide variety of different devices, without requiring alteration of the corresponding stylesheets.

As noted above, FIG. 4A shows an example of a content profile suitable for use in the content conditioning process of FIG. 3. In this example, the content profile includes a summarization program which attempts to determine the key points of the original XML document such that the resulting information output is approximately 25% of the original information from the document. The result of applying such a content profile to an XML document having the text shown in section 22 of FIG. 2A results in the summarization text shown in section 26 of FIG. 2B.

FIGS. 4B and 4C show other examples of content profiles in accordance with the invention. The content profiles in these examples may be used in the content conditioning process of FIG. 3. In the FIG. 4B example, a user has requested content to be presented on a public terminal. The request in this example may be of the following form:

<Content-Request>

<Authorization-request-parameters>

<Requester-ID> UIN879452AX </Requester-ID>
<Location-of-Requester> public terminal </Location-of-
Requester>
<Requester-Role> Eye specialist </Requester-Role>
<Requester-Authority> specialty Full Access
</Requester-Authority>
<Requester-Group-Membership> Technical Staff
</Requester-Group-Membership>
<Time-of-Request> 9:30AM </Time-of-Request>
<Date-of-Request> 11/11/2000 </Date-of-Request>

</Authorization-request-parameters>

</Content-Request>

The content profile of FIG. 4B is configured to implement an authorization filter which ensures that the user is only permitted to view information relevant to his or her area of expertise. For example, an eye specialist may be permitted to look at a diabetic record of a patient but not a psychiatric record of that patient. An authorization system may be used to check the request and to generate the content profile of FIG. 4B for presentation of the authorized information on the public terminal.

The FIG. 4C example shows a content profile suitable for use in conjunction with a device which has only an audio player or speech synthesizer, but no visual display. The content profile in this example indicates that the presentation should include news heading and news body information, but no pictures or video. Summarization is used, and the sentences presented are shorter than those that would be presented, e.g., as written text in a display generated by a PC browser. The relative informativeness or strength of the words is used to adjust the pitch prominence.

Of course, the content profiles described above are only examples, and other types of profiles may be used to provide any desired type of content conditioning appropriate to presentation of particular content on a particular device.

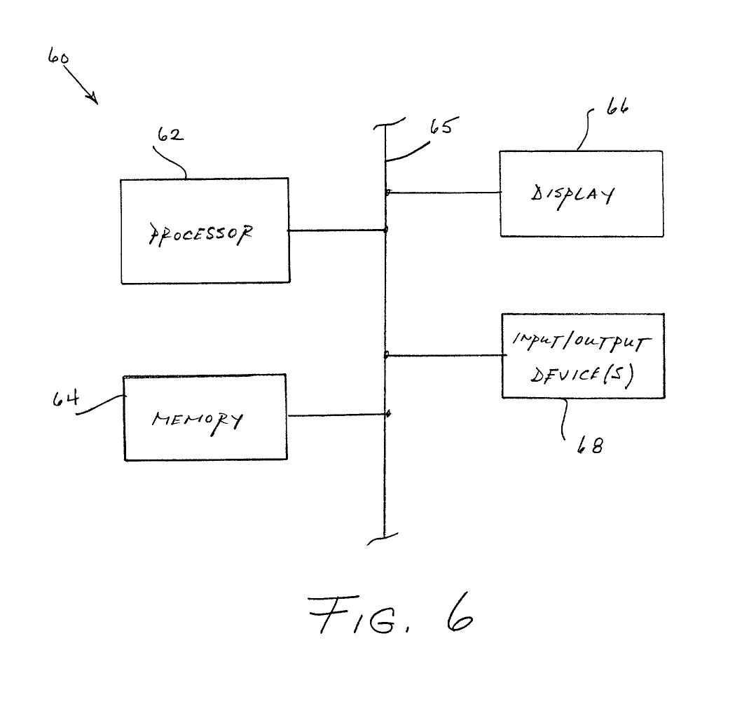

An advantage of the present invention is that a wide variety of system architectures can be used to implement the content conditioning process of FIG. 3. Server-side and client-side architectures will now be described in conjunction with FIGS. 5A and 5B, respectively.

FIG. 5A shows a portion of a communication system which includes a content provider 50, a server 52 and a client 54, configured in accordance with one possible implementation of an illustrative embodiment of the invention. In this implementation, the content conditioning process is implemented within the server 52. The server 52 keeps track of different content profiles, schemas, and stylesheets for the devices it supports. The server 52 in an XML generation operation 55 processes content received from content provider 50 so as to generate the original XML document 30. The server 52 further includes the content conditioner 32 and the XSL engine 36 of FIG. 3. The server 52 utilizes these elements in conjunction with content profile 33A, schema 34A, and stylesheet 37A to generate presentation 38A for device A in the manner described previously.

The server 52 may be a web server coupled to the client 54 over the Internet or other communication network. Both devices A and B are associated with client 54 in this implementation, but could be viewed as separate clients.

FIG. 5B shows another possible implementation of an illustrative embodiment of the invention. In this implementation, the content conditioning process is implemented within the device itself. A server 52′ in XML generation operation 55 processes content received from content provider 50 so as to generate the original XML document 30. This document is supplied over the Internet or other communication network to device A as shown. Device A in this implementation includes the content conditioner 32 and the XSL engine 36 of FIG. 3. Device A utilizes these elements in conjunction with content profile 33A, schema 34A, and stylesheet 37A to generate presentation 38A for device A in the manner described previously. Device A stores only the content profile, schema and stylesheet required for that device. Such elements for other devices, such as device B, are stored on that device. The client-side implementation of FIG. 5B generally requires a more powerful client platform than in the server-side implementation of FIG. 5A.

As noted above, other architectures could also be used. For example, the content profile and schema processing may be implemented in the server 52, while the stylesheet processing is implemented in the client device. In this case, the content conditioner 32 is implemented in the server, while the XSL engine 36 is implemented in the client device.

FIG. 6 shows an example of a processing device 60 that may be used to implement, e.g., device A in FIG. 5B. The device 60 includes a processor 62 and a memory 64 which communicate over at least a portion of a set 65 of one or more system buses. Also utilizing at least a portion of the set 65 of system buses are a display 66 and one or more input/output (I/O) devices 68. The device 60 may represent a desktop or portable computer, a personal digital assistant (PDA), a wireless telephone, a smart remote control, a television or any other type of processing device for which it is desirable to provide conditioned content. The elements of the device 60 may be conventional elements of such devices.

For example, the processor 62 may represent a microprocessor, central processing unit (CPU), digital signal processor (DSP), or application-specific integrated circuit (ASIC), as well as portions or combinations of these and other processing devices. The memory 64 is typically an electronic memory, but may comprise or include other types of storage devices, such as disk-based optical or magnetic memory. The display 66 may be used to generate visually-perceptible outputs such as those previously described in conjunction with FIGS. 2A and 2B. The one or more I/O devices 68 will typically include a network interface for interfacing to the Internet or other communication network.

The content conditioning techniques described herein may be implemented in whole or in part using software stored and executed using the respective memory and processor elements of the device 60. For example, the content conditioner 32 and XSL engine 36 of FIGS. 3 and 5 may be implemented at least in part using one or more software programs stored in memory 64 and executed by processor 62. The particular manner in which such software programs may be stored and executed in device elements such as memory 64 and processor 62 is well understood in the art and therefore not described in detail herein.

It should be noted that the device 60 may include other elements not shown, or other types and arrangements of elements capable of providing the content conditioning functions described herein.

In addition, similar arrangements of processor and memory elements may be used to implement the server 52 in the server-side implementation as shown in FIG. 5A. In such an arrangement, for example, the display 66 may be eliminated.

The above-described embodiments of the invention are intended to be illustrative only. For example, the invention can be used in other types of information processing systems and devices using other arrangements of processing elements. In addition, as indicated above, the particular content profile and schema may vary depending upon the device and the processing application. These and numerous other embodiments within the scope of the following claims will be apparent to those skilled in the art.

What is claimed is:

1. A method for conditioning content for presentation at a processing device, the method comprising the steps of:
determining a content profile associated with the device;
generating a conditioned document by applying the content profile to a requested document containing content for presentation at the device;
determining a stylesheet associated with the device; and
applying the stylesheet to the conditioned document to generate an output suitable for presentation at the device.

2. The method of claim 1 wherein the retrieved document comprises an extensible mark-up language document.

3. The method of claim 1 further including the steps of determining a schema associated with the device, and generating the conditioned document by applying the content profile and the schema to the requested document.

4. The method of claim 1 wherein the first applying step is implemented in a content conditioner element of the processing device.

5. The method of claim 1 wherein the first applying step is implemented in a content conditioner element of a server which stores at least a portion of the requested document.

6. The method of claim 1 wherein the second applying step is implemented in an extensible stylesheet language engine element of the processing device.

7. The method of claim 1 wherein the second applying step is implemented in an extensible stylesheet language engine element of a server which stores at least a portion of the requested document.

8. The method of claim 1 wherein the content profile for a given device comprises one or more operations and corresponding parameters that are required to condition the requested document content for a desired consumption experience at the processing device.

9. The method of claim 1 wherein the content profile comprises a summarization program which specifies a manner in which summarization information derived from the retrieved document is to be presented at the device.

10. The method of claim 1 wherein the content profile specifies a maximum percentage of an amount of original text associated with the requested document that is to be presented at the device.

11. The method of claim 1 wherein the output is presented in a visually-perceptible manner on a display of the device.

12. The method of claim 1 wherein the output is presented in an audibly-perceptible manner using a speaker associated with the device.

13. The method of claim 1 wherein the processing device comprises a desktop or portable personal computer.

14. The method of claim 1 wherein the processing device comprises a personal digital assistant.

15. The method of claim 1 wherein the processing device comprises a wireless telephone.

16. The method of claim 1 wherein the processing device comprises an Internet-enabled television.

17. An apparatus for conditioning content for presentation at a processing device, the apparatus comprising:
a memory for storing at least a portion of a content profile associated with the device; and
a processor coupled to the memory, the processor being operative: to generate a conditioned document by applying the content profile to a requested document containing content for presentation at the device; to determine a stylesheet associated with the device; and to apply the stylesheet to the conditioned document to generate an output suitable for presentation at the device.

18. An article of manufacture comprising a machine-readable storage medium containing one or more software programs for conditioning content for presentation at a processing device, wherein the one or more software programs when executed implement the steps of:
determining a content profile associated with the device;
generating a conditioned document by applying the content profile to a requested document containing content for presentation at the device;
determining a stylesheet associated with the device; and
applying the stylesheet to the conditioned document to generate an output suitable for presentation at the device.
